(19) United States
(12) Patent Application Publication
(10) Pub. No.: US 2025/0029289 A1
(43) Pub. Date: Jan. 23, 2025

(54) UNSUPERVISED LEARNING WITH SYNTHETIC DATA AND ATTENTION MASKS

(71) Applicant: Lemon Inc., Grand Cayman (KY)

(72) Inventors: Song BAI, Singapore (SG); Junhao ZHANG, Singapore (SG); Chuhui XUE, Singapore (SG); Wenqing ZHANG, Singapore (SG)

(21) Appl. No.: 18/755,479

(22) Filed: Jun. 26, 2024

(30) Foreign Application Priority Data
Jul. 18, 2023 (SG) 10202302027W

(51) Int. Cl. G06T 11/00; G06F 40/186

(52) U.S. Cl. CPC G06T 11/00; G06F 40/186

(57) ABSTRACT

Embodiments of the disclosure relate to unsupervised learning with synthetic data and attention masks. According to example embodiments of the disclosure, a plurality of sample images are generated by providing a plurality of text prompts into a trained generative model, respectively. For a sample image of the plurality of sample images, at least one attention map is obtained from a generative model, the at least one attention map being determined by the generative model for generating the sample image, an attention map indicating visual elements of an object within the sample image. Training of a target model is performed according to unsupervised learning at least based on the plurality of sample images and attention maps for the plurality of sample images, the target model being configured to perform an image processing task.

### CROSS-REFERENCE

The present application claims priority to Singaporean Patent Application No. 10202302027W, filed on Jul. 18, 2023 and entitled “UNSUPERVISED LEARNING WITH SYNTHETIC DATA AND ATTENTION MASKS”, the entirety of which is incorporated herein by reference.

### BACKGROUND

Unsupervised learning is a type of machine learning where models learn to identify patterns or structures in data without explicit labels. In the past few years, several unsupervised learning techniques have emerged, including contrastive learning, masked modeling, and vision-language pretraining, or the like. Although these advancements have led to significant progress in visual representation learning, the majority of them rely on training on large-scale datasets which contains millions of images. However, manually building a sizable dataset with decent richness and diversity is often time-consuming and costly. Moreover, present-day concerns about data privacy and usage rights further complicated the acquisition of massive data, creating additional obstacles to the development of unsupervised learning.

### SUMMARY

According to implementations of the subject matter described herein, there is proposed a solution for unsupervised training based on model-generated data. According to example embodiments of the present disclosure, a plurality of sample images are generated by providing a plurality of text prompts into a trained generative model, respectively. For a sample image of the plurality of sample images, at least one attention map is obtained from a generative model, the at least one attention map being determined by the generative model for generating the sample image, an attention map indicating visual elements of an object within the sample image. Training of a target model is performed according to unsupervised learning at least based on the plurality of sample images and attention maps for the plurality of sample images, the target model being configured to perform an image processing task.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, where:

FIG. 1 illustrates a block diagram of an example environment in which various embodiments of the present disclosure can be implemented;

FIG. 2 illustrates a block diagram of a model training system in accordance with some example embodiments of the present disclosure;

FIGS. 3A-3C illustrate example comparisons between current unsupervised learning frameworks and the unsupervised learning frameworks according to some example embodiments of the present disclosure;

FIG. 4A illustrates a block diagram of unsupervised contrastive learning in accordance with some example embodiments of the present disclosure;

FIG. 4B illustrates a block diagram of an example unsupervised learner for masked modeling in accordance with some example embodiments of the present disclosure;

FIG. 4C illustrates an example of vision-language pretraining in accordance with some example embodiments of the present disclosure;

FIG. 5 illustrates a flowchart of a computer-implemented method in accordance with some example embodiments of the present disclosure; and

FIG. 6 illustrates a block diagram of an example computing system/device suitable for implementing example embodiments of the present disclosure.

### DETAILED DESCRIPTION

Principle of the present disclosure will now be described with reference to some example embodiments. It is to be understood that these embodiments are described only for purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for purpose of describing particular embodiments only and is not intended to be limiting example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “model” is referred to as an association between an input and an output learned from training data, and thus a corresponding output may be generated for a given input after the training. The generation of the model may be based on a machine learning technique. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. Generally, the validation stage may be considered as a step in a training process, or sometimes may be omitted. At the application stage, the resulting machine learning model may be used to process a real-world model input based on the set of parameter values obtained from the training process and to determine the corresponding model output.

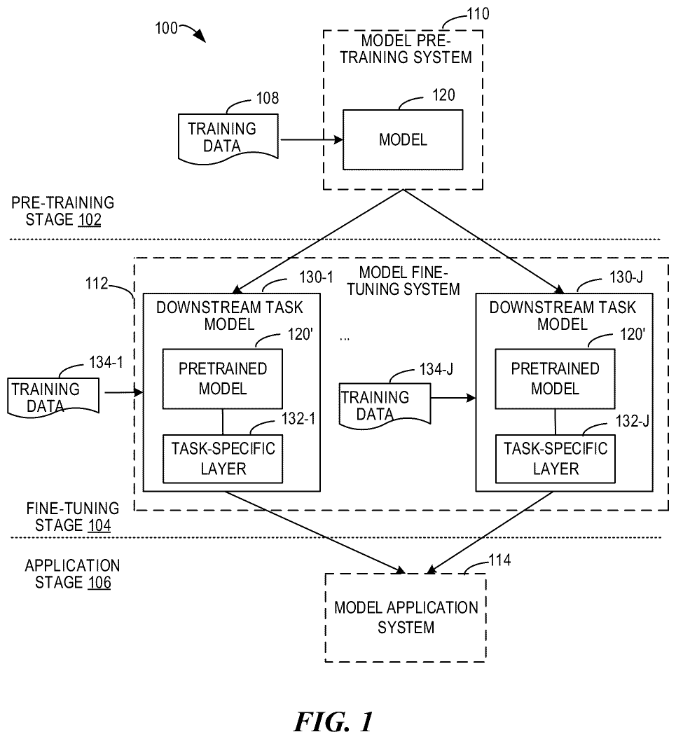

FIG. 1 illustrates a block diagram of an example environment 100 in which various embodiments of the present disclosure can be implemented. In the environment of FIG. 1, three different stages are shown, including a pre-training stage 102, a fine-tuning stage 104, and an application (inference) stage 106. The pre-training stage 102 and a fine-tuning stage 104 may be both considered as a model training phase of a model. It is noted that after the pre-training stage or fine-tuning stage is completed, there can also be a test phase, which is not shown in the figure.

In the pre-training stage 102, a pre-training system 110 is configured to pre-train a machine learning model (i.e., a model 120) which can be configured to learn from training data 108 accurate representations of input data (also known as feature representations or features of the input data). Before the pre-training, parameter values of model 120 may be randomly initialized. The pre-training for the model 120 is performed with the training data 108. The parameter values of the model 120 may be updated and adjusted during the pre-training process. After the pre-training, a pre-trained model 120′ may be obtained. At this time, the parameter values of the pre-trained model 120′ have been updated as pre-trained parameter values. In the embodiments of the present disclosure, the pre-trained model 120′ may be used as a feature extraction model, which is configured to extract a feature representation of input data.

Through the pre-training stage 102, the model 120 may learn a strong generalization capability from the large scale of training data 108. The pre-trained model 120′ may be provided to a model fine-tuning system 112. The pre-trained model 120′ may be fine-tuned in the model fine-tuning system 112 for one or more downstream tasks. In some example embodiments, for different downstream tasks, the pre-trained model 120′ may be connected to different task-specific layers 132-1, . . . , 132-J (collectively or individually referred to as task-specific layers 132) to build different downstream task models 130-1, . . . , 130-J (collectively or individually referred to as downstream task models 132). This is because different downstream tasks require different outputs. The pre-trained model 120′ may extract a feature representation of a model input and provide it to the task-specific layer 132 to generate an output for the corresponding task.

In the fine-tuning stage 104, according to the requirements of specific downstream tasks, corresponding training data 134-1, . . . , 134-J may be selected to fine tune the built downstream task models 130-1, . . . , 130-J, respectively. The corresponding model training algorithm is also adopted to update and adjust the parameters of the overall model. Since the pre-trained model 120′ has learned a lot from the training data in the pre-training stage, a small amount of training data is needed in the fine-tuning stage 104 to derive a downstream task model that meets the expectation.

In some example embodiments, in the pre-training phase 102, one or more task-specific layers may have been built to pre-train the model 120 for a plurality of downstream tasks according to the requirements of the pre-training objectives. In this case, if a task-specific layer for use in a certain downstream task is the same as the task-specific layer built for the pre-training, the pre-trained model 120′ and the task-specific layer may be directly used to form the corresponding downstream task model. In this case, the downstream task model may not require fine-tuning, or only require fine-tuning of a small amount of training data.

In the application phase 106, the obtained downstream task model may be provided to one or more model application systems 114 for use. In the application phase 106, each downstream task model may be used to process a corresponding input in the practical scenario and provide a corresponding output.

In FIG. 1, the model pre-training system 110, the model fine-tuning system 112, and the model application system 116 may include any computing system or device with the computing capability, such as various computing devices/systems, terminal devices, servers, and the like. Terminal devices may include any type of mobile terminal, fixed terminal or portable terminal, including mobile phone, desktop computer, laptop computer, netbook computer, tablet computer, media computer, multimedia tablet, or any combination thereof, including accessories and peripherals of these devices or any combination thereof. Servers include but are not limited to mainframe, edge computing nodes, computing devices in a cloud environment, and the like.

It would be appreciated that the components and arrangements in the environment 100 shown in FIG. 1 are only examples, and a computing system suitable for implementing the example embodiments described in the present disclosure may include one or more different components, other components, and/or different arrangements. For example, although being illustrated as separate systems, the model pre-training system 110, the model fine-tuning system 112, and the model application system 116 may be integrated in the same system or device. The embodiments of the present disclosure are not limited in this regard. The example embodiments of the model training and model application will be further described with reference to the accompanying figures.

As discussed, it is costly and time-consuming to manually collect a largescale labeled dataset for model training. In addition, recent concerns about data privacy and usage rights further hinder this process. In parallel, generative models that aim to model real-data distributions can now produce not only high-quality but also diverse images in a customized label space. In particular, recent generative models have made major breakthroughs in synthesizing multi-modal data. To overcome the challenges on the training data for models, using synthetic data for unsupervised pretraining presents itself as a logical option, given its advantageous characteristics such as cost-effectiveness, virtually limitless scalability, enhanced control over data distribution, and improved data privacy and security. There has been a lack of in-depth exploration focusing on unsupervised learning on model-generated data.

According to embodiments of the present disclosure, there is proposed an improved solution for unsupervised learning based on model-generated data. In this solution, a solution for unsupervised training based on model-generated data. According to example embodiments of the present disclosure, a plurality of sample images are generated by providing a plurality of text prompts into a trained generative model, respectively. For a sample image of the plurality of sample images, at least one attention map is obtained from a generative model, the at least one attention map being determined by the generative model for generating the sample image, an attention map indicating visual elements of an object within the sample image. Training of a target model is performed according to unsupervised learning at least based on the plurality of sample images and attention maps for the plurality of sample images, the target model being configured to perform an image processing task. The generative model can be utilized for generation high-quality and diverse synthetic images for training, to satisfy the requirement on large-scale training data for models. In addition, with the assistance information in the attention maps, unsupervised learning of models can be enhanced to boost model performance. As the attention maps are readily available from the generative model, no extra efforts are needed for model configuration or training.

Some example embodiments of the present disclosure will be described in detail below with reference to the accompanying figures.

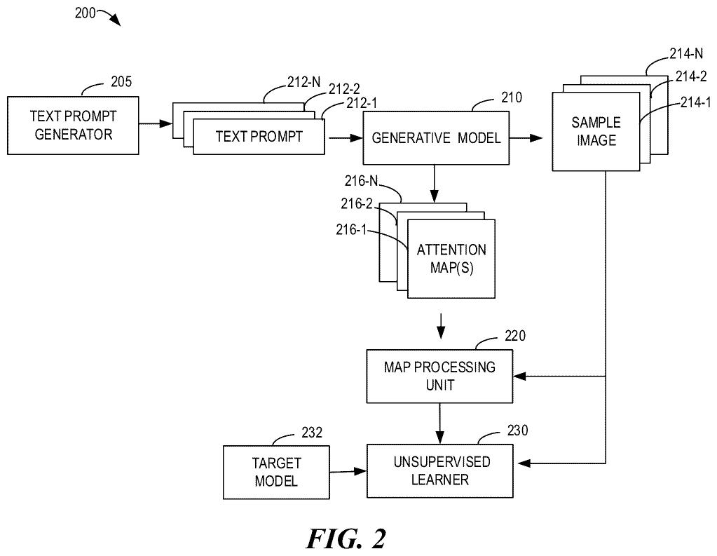

Reference is first made to FIG. 2. FIG. 2 illustrates a block diagram of a model training system 200 in accordance with some example embodiments of the present disclosure. In some example embodiments, the model training system 200 may be implemented as either or a combination of the model pre-training system 110 and the model fine-tuning system 120 in the environment 100 of FIG. 1.

As will be discussed below, the model training system 200 is configured to train a target model 232 which is configured to perform an image processing task. In some example embodiments, the target model 232 may be configured for image classification, object detection, image segmentation, image-text retrieval, or the like. In some example embodiments, the target model 232 may be configured as a feature extractor for images, to extract image features for use by other models, decoders, or output layers. The target model 232 may be configured with any suitable model structure which can be trained through unsupervised learning techniques. In some example embodiments, the target model 232 to be trained may be a pre-trained model and the training here is to fine-tune the pre-trained model. In some other embodiments, the training here is to pre-train the target model 232 from scratch.

In embodiments of the present disclosure, the model training system 200 uses a generative model 210 for image generation, to generate a plurality of sample images 214-1, 214-2, . . . , 214-N (collectively or individually referred to as sample images 214), where N may be an integer larger than one. The sample images 214 may also be referred to as synthetic images, and can be used as training data of the target model 232.

In some example embodiments, the generative model 210 may be a text-to-image generative model. In this case, the input to the generative model 210 is a text prompt (or text token) which describes the expected image to be generated. The output from the generative model 210 is an image corresponding to the text prompt. In particular, the text-to-image generation can be treated as a conditional image generation task that requires the sample image to match the given natural language description (i.e., the text prompt). The generative model 210 can be used as an efficient means for synthetic data representation, to produce high-fidelity photorealistic images closer to real data since they are trained on real-world data and can also produce potentially unlimited synthetic data size. The generated images are highly condensed compared to synthetic data itself, and take up much reduced storage space.

There are various generative models to be adopted. In embodiments of the present disclosure, the generative model 210 is selected as a model which produces an attention map(s) for generating the output sample image 214. For example, the generative model 210 may include one or more cross-attention layers to generate one or more attention maps. Some examples of such generative models are first described, and then the attention maps are further discussed.

In some example embodiments, the generative model 210 may be a diffusion model for text-to-image. Diffusion models are a class of generative models. As a likelihood-based model, the diffusion models match the underlying data distribution q(x₀) by learning to reverse a noising process, and thus novel images can be sampled from a prior Gaussian distribution via the learned reverse path. These models commence with a straightforward random noise and progressively denoise it through numerous steps with learned transformations until it mirrors a sample from the desired data distribution. The diffusion models generally include one or more cross-attention layer to produce the cross-attention maps, which are employed for text-visual interaction and can accurately represent the foreground objects.

In some examples, the generative model 210 may be constructed as a large-scale text-to-image diffusion model such as the latent diffusion model, Stable Diffusion, Imagen, and GLIDE which have made considerable strides and produced striking visual outcomes. It is noted that any other types of diffusion models are also applicable.

In some example embodiments, the generative model 210 may be selected as other types of generative models such as a Generative Adversarial Networks (GAN)-based generator. In some example embodiments, instead of using text as input to generate images, the generative model 210 may be constructed as other types of generative models, for example, to generate images by given an image or a combination of an image, a text prompt, and/or other modal data. Although one generative model is illustrated, in some example embodiments, multiple generative models may be applied to generate the sample images for training the target model 232.

In some example embodiments for text-to-image generation, the model training system 200 may provide each of a plurality of text prompts 212-1, 212-2, . . . , 212-N (collectively or individually referred to as text prompts 212) into the generative model 210, so as to generate the plurality of sample images 214-1, 214-2, . . . , 214-N.

It is expected for the target model to encounter a wide variety of images in order to learn universal representations applicable to various downstream tasks. In some example embodiments, the text prompts 212 may be obtained from a label space for an available image dataset an/or from any other text sources. In some example embodiments, a text prompt 212 may indicate one or more object, e.g., include one or more object class name expressed in natural language.

As illustrated, the model training system 200 may comprise a text prompt generator 205 to generate the text prompts 212 from a plurality of object class names.

In some example embodiments, the text prompt generator 205 may the text prompt generator 205 to increase the diversity of text prompts and the generated sample images, so as to achieve language enhancement (LE) and to better unleash the potential of synthesized data. The text prompt generator 205 may generate one or more text prompts 212 by providing one or more class names into a trained word-to-sentence model, to obtain at least one text prompt 212 generated by the word-to-sentence model. The word-to-sentence model can generates diversified sentences containing the class names as language prompts for the text-to-image generation process. For example, if the class name is “airplane”, then the enhanced text prompt from the word-to-sentence model may be “a white airplane hovering over a beach and a city”. The enhanced text descriptions introduce rich context descriptions in the text prompts 212. In some example embodiments, for a class name, one or more text prompts may be generated by the word-to-sentence model, for example, by providing the class name into the word-to-sentence model for more than one time.

In some example embodiments, alternatively or in addition, the text prompt generator 205 may generate one or more text prompts 212 by filling one or more object class names into one or more predefined text templates. For example, a text prompt 212 sᵢ corresponding to one or more object class names cᵢ may be generated as s, =“a photo of {cᵢ}”. In some example embodiments, more than one text template may be defined to generate more than one text prompt for a class name.

In some example embodiments, to generate more realistic and diverse images, the text prompt generation may be further augmented. For example, a questioning and answering language model may be applied to generate more diversified text prompts. In some example embodiments, augmentation templates may be defined and provided to the questioning and answering language model to obtain output text prompts. In some example embodiments, the augmentation templates vary based on the hierarchical level of object class names, for example, “[Class (with other class)] is are [somewhere]” or “[Class] with [other class] is are [doing something] [somewhere]”.

As mentioned, during the generation of a sample image 214 in the generative model 210, one or more attention maps are produced and used by the generative model 210 for generating the sample image 214. For the generated sample images 214, the model training system 200 can obtain respective attention maps 216-1, 216-2, . . . , 216-N from the generative model 210. For the purpose of discussion, the attention maps 216-1, 216-2, . . . , 216-N are collectively or individually referred to as attention maps 216.

An attention map 216 (also referred to as “attention mask”) for a sample image 214 indicates visual elements of an object within the sample image 214. In an example, the attention map 216 may provide pixel-level information, to indicate pixel-level importance scores of visual elements within the sample image 214 with respect to an object. A higher importance score may indicate that the corresponding visual element is more important for an object, i.e., is belonging to the object.

For each sample image 214, one or more attention maps 216 may be obtained, depending on the number of objects present in the sample image 214. In some example embodiments, the attention maps 216-1, 216-2, . . . , 216-N may be determined as the text prompts 212. In some example embodiments, an attention map 216 for a sample image 214 may indicate visual elements of an object indicated by a text prompt 212 that is input for generating the sample image 214.

The generation of the attention maps 216 within the generative model 210 is briefly introduced. As a generative model, a text-to-image diffusion model uses a text prompt to create high-quality images through a controlled diffusion process. It first encodes the text prompt into a latent space representation, then uses a diffusion process to gradually transform a noise input into the final image, guided by the encoded text. The model represents the joint understanding of textual and visual data via cross-attention interactions in one or more cross-attention layers. Specifically, in the single diffusion step and layer, the text embedding from an input text prompt is projected into a key as K∈ [symbol] and the visual noise is projected into a query as Q∈ [symbol] , where L is the sequence length of the input text prompt, H and W are height and width of a visual feature, respectively, and C is the feature dimension. A cross-attention map is achieved by the multiplication of Q and K, resulting in:

$$A = Softmax ( \frac{Q {K}^{T}}{\sqrt{d}} ) \qquad ( 1 )$$

where A∈ [symbol] represents an attention map, illustrating the relationship between textual and visual elements. An attention map a∈ [symbol] corresponding to specific nouns such as “dog” in an L length sentence, is selected. Thus, if multiple objects are indicated in the text prompt, multiple attention maps a can be obtained for the objects, respectively.

In some example embodiments, in generation of a sample image 214, if the generative model 210 comprises a plurality of cross-attention layers, the attention maps produced by the plurality of cross-attention layers may be collected and combined to generate the attention map(s) 216 for the sample image 214. For example, if a diffusion model is used as the generative model 210, the attention maps derived from every layer and time step within the diffusion model may be collected. These attention maps are then resized and averaged to form a new map.

In embodiments of the present disclosure, in addition to using the synthetic sample images 214, the attention maps 216, which can offer pixel-level labels without any need for human annotations are also utilized for unsupervised learning of the target model 232, thus adding a new dimension to unsupervised learning. The model training system 200 comprises a unsupervised learner 230 configured to perform training of the target model 232 according to unsupervised learning at least based on the plurality of sample images 214 and attention maps 216 for the plurality of sample images 214. In some example embodiments, the model training system 200 may further comprise a map processing unit 220 to process the attention maps 216, and/or process the sample images 214 based on the attention maps 216, to make use of the attention maps 216 in the unsupervised learning.

Upon generating diverse model-generated images and complimentary attention maps, the unsupervised learning on the target model can be enhanced because the attention maps can provide additional information in the context of unsupervised learning.

Some examples of unsupervised learning are first introduced, and example embodiments of unsupervised learning based on the attention maps will further discussed.

Some examples of unsupervised learning may include contrastive learning (CL), masked modeling (MM), and vision-language pretraining (VLP), although other learning techniques may be further developed.

Contrastive learning aims to learn representations or features that can distinguish between a positive sample pair (similar examples) and a negative sample pair (dissimilar examples). For image data, contrastive learning is to learn image features that can distinguish between the positive sample pair (similar images) and the negative sample pair (dissimilar images), to make the features of the positive sample pair to be as close to each other as possible and make the features of the negative sample pair to be as far away from each other as possible.

Conventional techniques treat an image with a single object as a complete entity and conduct random crop and augmentations to get positive sample pairs at the image level. Yet, such a paradigm is not suitable for model-generated images containing multiple objects. In some cases, the generative models have the capability to produce diverse images featuring more than one object by utilizing different text tokens. The diversity of model-generated images, which often include multiple objects (or instances), presents a significant challenge for traditional random crops in contrastive learning. This is due to the high risk of positive sample pairs being originated from distinct objects, resulting in ambiguity in model training as the discriminate features of each object are pulled in.

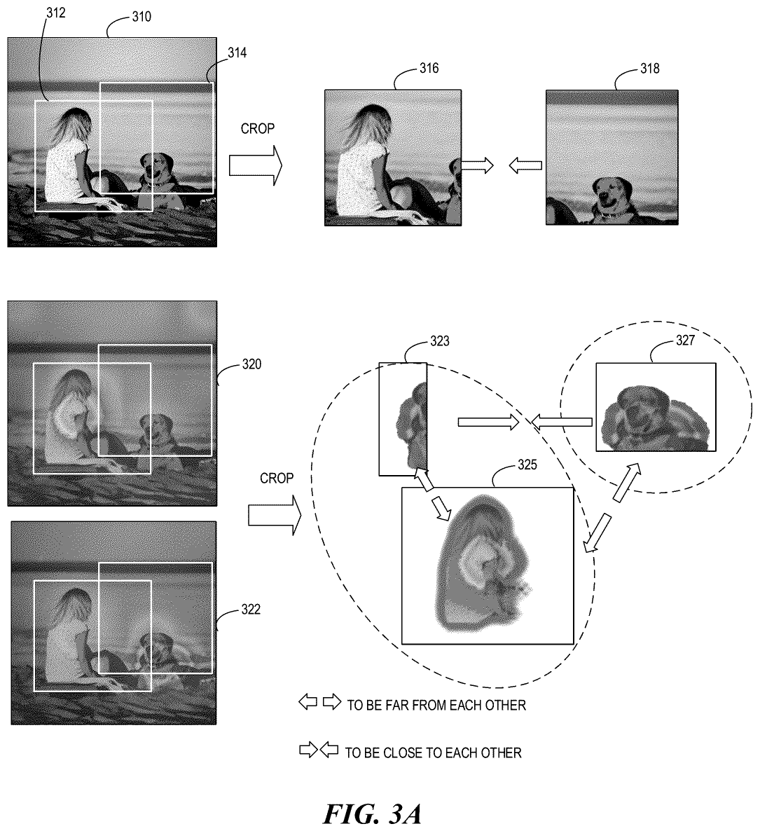

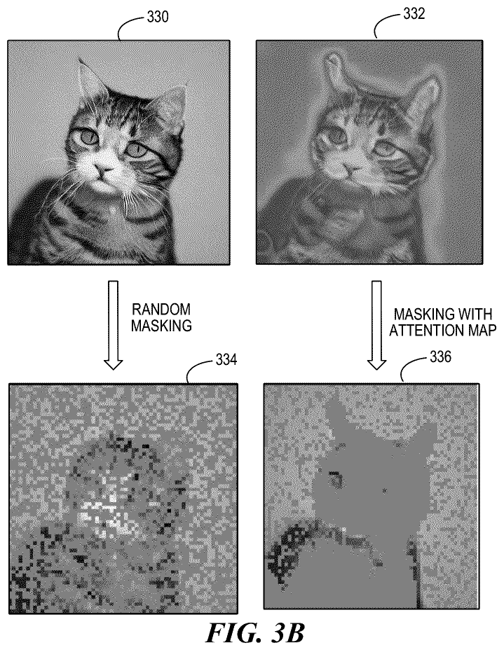

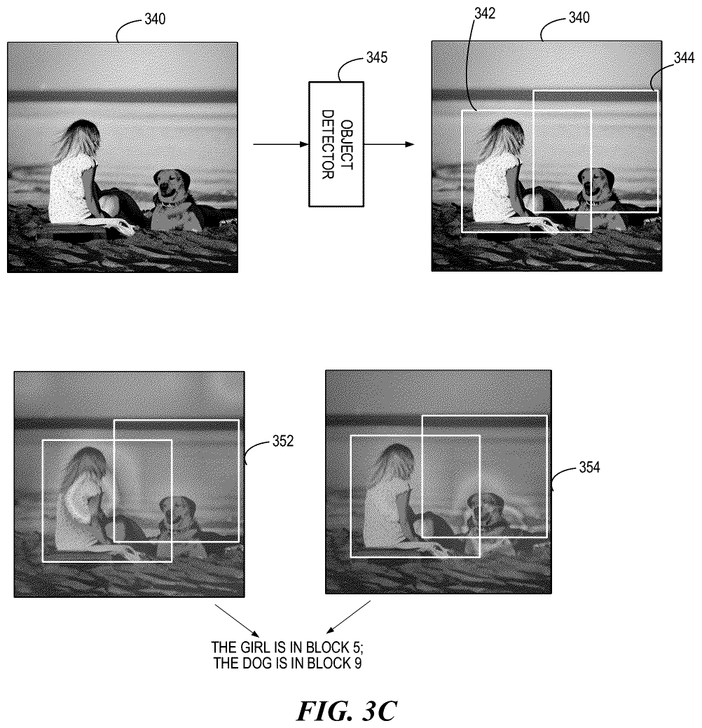

As shown in the top row of FIG. 3A, if an image 310 includes two objects, a girl and a dog. By randomly cropping two patches 312 and 314 from the image 310 to generate a pair of images 316 and 318, conventional contrastive learning may consider the pair of images 316 and 318 as a positive sample pair and train the model to learn similar feature representations for this pair although they contains different objects.

To mitigate this issue, in some example embodiments of the present disclosure, the free attention maps 216 from the generative model 210 can be utilized to ensure that each positive sample pair comes from the same object. Meanwhile, negative sample pairs are formed by selecting visual elements of different objects based on their corresponding attention maps. As shown in the bottom row of FIG. 3B, an attention map 320 for the object “girl” may be utilized to identify the visual elements 325 of the object “girl” from the image 310, and an attention map 322 for the object “dog” to identify the visual elements 323 and 327 of the object “dog” from the image 310. That is, the attention maps can assist in the acquisition of precise information for contrastive learning. As a result, the contrastive learning can be performed to make the features of the positive sample pair (the visual elements 323 and 327) to be as close to each other as possible and make the features of the negative sample pair (the visual elements 323 and 325, or the visual elements 327 and 325) to be as far away from each other as possible.

Masked modeling in computer vision tasks is to train a model to reconstruct masked visual patches of images. Examples of masked modeling-based models include MAE, SimMIM, and iBOT. Conventional masked modeling solutions are to randomly mask a training sample. As shown in the left column of FIG. 3B, an image 330 is randomly masked to derive a masked image 334, which is input to a model to be trained. The aim of the masked modeling is to train the model to reconstruct the masked patched in the masked image 334.

It has been proved that the patches of the images which are hard to reconstruct are usually consistently located within foreground objects. By restoring these particular patches rather than randomly-masked ones, the model can acquire more focused features. Inspired by this, as indicated in the right column of FIG. 3B, with a freely available attention map 332 from a generative model for generating the image 330, important visual elements may be identified and masked for training.

Vision-and-language pretraining is developed to jointly pretrain visual and text features using image-text matching by learning to align and translate between the two modalities of data. Models based on the vision-and-language pretraining predominantly rely on position features, such as those belonging to the objects of interest in an image, to gain a better understanding of the relationships between words and objects.

Conventional vision-and-language pretraining, as shown in the top row of FIG. 3C, an object detector 345 is adopted to detect bounding boxes 342 and 344 of objects in an image 340. Nonetheless, locating the objects through the use of bounding boxes predicted by object detection algorithms can be a time-consuming process. Additionally, the quality of the position features is heavily dependent on the performance of the object detectors, which may ultimately limit the strength of vision-and-language pretraining models. In example embodiments of the present disclosure, the attention maps from the generative models naturally align each text prompt with its corresponding object position.

In example embodiments of the present disclosure, attention maps can be utilized to supply position information without requiring the extra step of object detection. As shown in the bottom row of FIG. 3C, an attention map 352 for the object “girl” and an attention map 354 for the object “dog” in the image 340 can indicate the positions of the two objects within the image. This not only brings greater efficiency to vision-and-language pretraining models, but also enhances their overall effectiveness.

As discussed above, the attention maps for the model-generated sample images may be fully exploited to augment different unsupervised learning techniques, thereby enhancing performance on the target models. More details for the unsupervised learning based on the attention maps are provided below.

In some example embodiments, it is assumed that the unsupervised learner 230 is to apply contrastive learning to train the target model 232. Such target model 232 may also be referred to as a contrastive learning model or contrastive learning network. The target model 232 is trained to extract features from images.

As discussed above, contrastive learning is built upon the foundational idea of drawing positive sample pairs nearer while distancing negative sample pairs in the representational space. The unsupervised contrastive learning is to learn visual representations without the need for labeled data. As previously discussed in the introduction, using image-level features can be problematic when an image contains multiple instances, such as a girl and a dog. The augmented positive pairs, after random cropping, may contain different instances. This could negatively impact network training, as the distinct instance features that should be differentiated are instead conflated. To mitigate this, in some example embodiments, features based on the attention maps in place of image features are utilized for training.

Specially, for a given sample image 214, the target model 232 may extract at least one feature of the given sample image 214. Then the at least one feature is masked with the attention map(s) 216 obtained for this sample image 214. If the sample image 214 includes at least two objects, then at least two attention maps for the at least two objects are masked on the extracted feature(s), respectively, to obtain at least two masked features for the at least two objects. After masking with an attention map for an object, a masked feature comprises feature information related to an object. This allow constructing at least one positive sample pair and at least one negative sample pair from the at least two masked features, where a positive sample pair comprises a pair of masked features for a same object, and a negative sample pair comprises a pair of masked features for a pair of different objects. Then a contrastive loss for the sample image may be determined based on at least one similarity between the at least one positive sample pair and at least one similarity between the at least one negative sample pair, which can be used to train the target model 232.

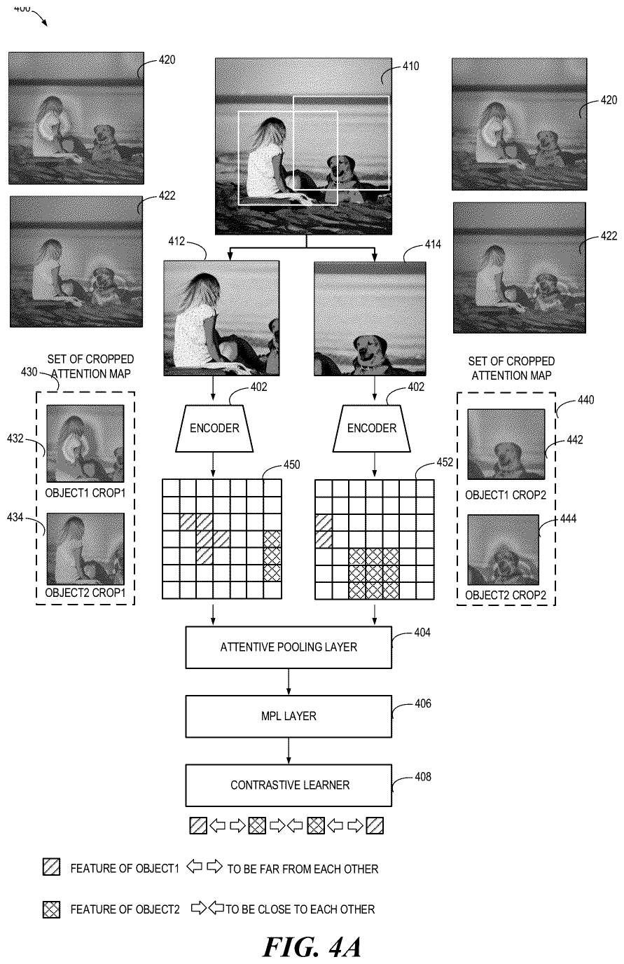

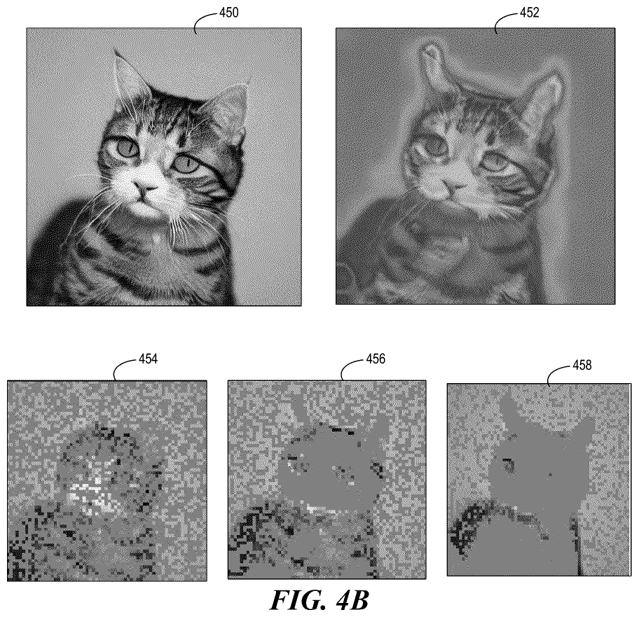

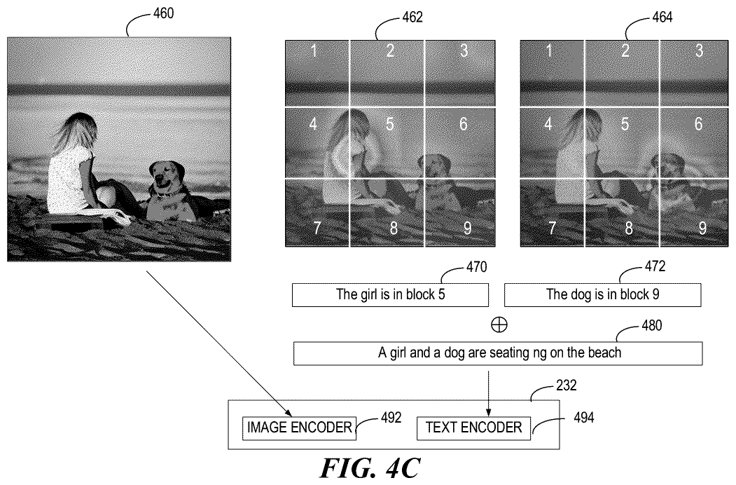

Depending on different implementations of unsupervised contrastive learning (e.g., SimCLR or MoCo-v2), the constructing of positive sample pairs and negative sample pairs may be different. FIG. 4A illustrates a block diagram of unsupervised contrastive learning architecture 400 in accordance with some example embodiments of the present disclosure.

As shown, it is assumed that a sample image 410 (which is an example of the sample images 214 generated by the generative model 210) is used to train the target model 232 which comprises an encoder 402 for feature extraction. Given the sample image 410, a series of augmentations and cropping operations may be applied, resulting in a plurality of cropped images. In the illustrated example, it is assumed that two cropped images 412, 414 are obtained by applying a first cropping operation and a second cropping operation on the sample image 410 although more than two cropped images may be applied. The two cropped images 412, 414 are denoted as x, x′. In some examples, random cropping operations may be applied on the sample image 410.

Further, attention maps 420, 422 for the sample image 410 is also cropped in line with the image operations (e.g., augmentations and cropping) yielding a set of cropped attention maps 430 a¹, . . . , a^{N} that is corresponding to the cropped image 412, and a set of cropped attention maps 440, a′¹, . . . , a′^{N} that is corresponding to the cropped image 414. The attention map 420 indicates visual elements of interest for the object “girl” in the sample image 410, and the attention map 422 indicates visual elements of interest for the object “dog” in the sample image 422.

Each set of cropped attention maps 430, 440 containing N objects (N is 2 in the illustrated example). More specifically, an cropped attention map 432 “Object 1 Crop 1” in the set of cropped attention maps 430 is cropped from the attention map 420 by applying the first cropping operation, and an cropped attention map 434 “Object 2 Crop 1” in the set of cropped attention maps 430 is cropped from the attention map 422 by applying the first cropping operation. Similarly, an cropped attention map 442 “Object 1 Crop 2” in the set of cropped attention maps 440 is cropped from the attention map 420 by applying the first cropping operation, and an cropped attention map 444 “Object 2 Crop 2” in the set of cropped attention maps 440 is cropped from the attention map 422 by applying the first cropping operation. The processing on the attention maps may be implemented at the map processing unit 220.

The cropped images 412 and 414 x, x′ are then input into the encoder 402, resulting in two features maps 450, 452, denoted as z=f(x), z′=f(x′), respectively, Next, an attentive pooling layer 404 is configured to applying attentive pooling. The cropped attention maps for the m-th object may be a^{m}, a′^{m} which are resized to match the spatial resolution of the encoded features 450, 452, are mapped to the features 450, 452, thereby applying attentive pooling. After the attentive pooling with the cropped attention maps a^{m}, a′^{m} for the m-th object, the features 450, 452 a^{m}, a′^{m} may be processed as massked features [symbol] , [symbol] , which includes feature information related to m-th object, and feature information related to other objects are masked. This process results in:

$${z}^{m} = \frac{1}{{\sum }_{i , j} {a}_{i , j}} {\sum }_{i , j}^{h , w} {a}_{i , j} {z}_{i , j} , \qquad ( 2 )$$

and [symbol] may be determined in a similar way, where [symbol] , [symbol] ∈ [symbol] . Following the application of attention pooling, the features [symbol] and [symbol] are transitioned from the image level to the instance level. Subsequently, a straightforward Multilayer Perceptron (MLP) layer 406 may be applied to these masked features. For instance-level features, the contrastive loss for z^{m} may be redefine as:

$$l = - log \frac{exp ( sim ( {z}^{m} \cdot {z}^{′ m} )}{exp ( sim ( {z}^{m} \cdot {z}^{′ m} ) ) + {\sum }_{n = 1 ⌈ m \neq n ⌉}^{N} exp ( sim ( {z}^{m} \cdot {z}^{n} ) )} , \qquad ( 3 )$$

where

$$sim ( {z}^{m} , {z}^{′ m} ) = \frac{{z}^{m ⊤} \cdot {z}^{′ m}}{\vert {z}^{m} \vert \cdot {z}^{′ m} \vert} .$$

In this loss computation, the features of the same object from the two crop images as the positive sample pair, and the features of different objects as negative sample pairs. In Equation (3), N signifies the total number of objects in the image. When extended to the batch dimension, N can represent the total number of objects in the batch of sample images.

In some example embodiments, for other contrastive learning model such as MoCo-v2, the encoders for the two image crops are distinct. One encoder is updated by the Exponential Moving Average (EMA) of the other encoder. Furthermore, instance-level features, as opposed to image-level, are updated and stored in the memory bank. In addition to addressing the issue where positive sample pairs may comprise different instances, this strategy enables every image to provide a wealth of information. This greatly aids the network and allows for the learning of a more diverse representation, given the fact that each image typically encompasses multiple instances.

In some example embodiments, it is assumed that the unsupervised learner 230 is to apply masked modeling to train the target model 232. Such target model 232 may also be referred to as a masked modeling model. The target model 232 is trained to extract features from images.

As discussed above, certain image patches can be challenging to reconstruct, and these often represent the foreground objects in images. Prioritizing the reconstruction of these difficult patches aids the network in learning a more discriminative representation. To accomplish this, in conventional solution, an additional teacher-student network to predict these difficult patches. However, deploying an extra teacher-student model will bring extra computation costs and complicate the learning process. In contrast, the freely available attention map naturally embodies the importance score of the foreground object mask. The importance scores of the attention map, ranging from low to high, correspond to patches from easy to difficult. This allows to discard the teacher-student model for identifying challenging patches.

In some example embodiments, given a sample image 214, at least one patch in the sample image may be masked based on the at least one attention map 216 for the sample image 214. The target model 232 may be trained by performing masked modeling to reconstruct the at least one masked patch in the sample image 214.

In some example embodiments, an attention map 216 for a sample image 214 comprises importance scores of visual elements within the sample image 214 with respect to an object. In masking the sample image, at least one patch in the second sample image is selected for masking based on importance scores comprised in the at least one attention map. The at least one masked patch corresponds to higher importance scores in an attention map than unmasked patches.

An intuitive approach would be to mask the patches with the highest attention scores and then use pretraining from scratch to reconstruct the masked images. However, solely focusing on reconstructing the difficult patches may cause the network to overly concentrate on the foreground object, which could be detrimental to learning a more universal representation of the entire image. To mitigate this, in some example embodiments, a balanced masking technique for masked modeling that gradually increases the masking ratio of foreground object patches. This strategy enables the model to learn both universal and targeted representations during the masked modeling. More specifically, a sample image 214 is used iteratively in training the target model 232. In a first training iteration of the target model, a first ratio of patches among the plurality of patches in the second sample image is selected for masked based on the corresponding attention map(s). The first ratio is larger than a second ratio of patches masked in the second sample image in a training iteration earlier than the first training iteration.

During the initial stages of training, the patches of a sample image are masked randomly. As the training epochs increase, the ratio of masked patches determined by the highest importance scores may be gradually raised, the ratio of randomly selected masked patches is reduced. As shown in FIG. 4B, for a sample image 450 and its attention map 452, a randomly-masked image 454 is initially used for training. As the training epochs increase, the attention map 452 is utilized to select a higher ratio of masked patched, resulting in a masked image 456, a masked image 458, and so on. This balanced approach enables the network to learn both universal and targeted representations simultaneously.

In some example embodiments, it is assumed that the unsupervised learner 230 is to apply vision-and-language pretraining to train the target model 232. Such target model 232 may also be referred to as a vision-language model. In the vision-and-language pretraining, the model-generated sample images 214 may be used as vision data, and the text prompts 212 or text sequences generated based on the text prompts 214 can be used as language or textual data. The target model 232 is pretrained to extract aligned or matched feature representations for paired vision and language data. The target model 232 may include an image encoder to extract image features and a text encoder to extract textual features.

The capacity for position grounding is vital for a vision-language model to perform cross-modality downstream tasks. Some studies strive to enhance this capability by incorporating bounding box and region features as additional visual inputs during vision-language pretraining. However, obtaining these features and bounding boxes for the objects in the image necessitates the use of a robust, pre-trained offline detection model. This process can be time-consuming and often results in a significant increase in the parameters for the vision-language models. In contrast, in some example embodiments of the present disclosure, synthetic data inherently includes the bounding box of the object (nouns). This is made possible to readily transform the attention map into a binary mask, with pixels marked as ‘1’ representing the foreground region, thereby allowing to obtain the bounding box of an object.

Rather than extracting regions using bounding boxes as inputs for the image encoder, in the example embodiments of the present disclosure, position-aware prompts are employed, which does not impose additional parameters or computational demands on the vision-language model. In some example embodiments, given a sample image 214, at least one location of at least object within the sample image 214 may be determined based on at least one attention map 216 for the sample image 214. The vision-and-language pretraining of the target model 232 may be performed based at least in part on the sample image and location information indicating the at least one location of the at least object within the sample image.

FIG. 4C illustrates an example of vision-and-language pretraining in accordance with some example embodiments of the present disclosure. As illustrated in FIG. 4C, a sample image 470 is divided into N blocks (9 blocks in the illustrated example). After determining the bounding box of the object based on the attention maps 462 and 464, the blocks in which the center of the objects are located may be identified as the locations of the objects.

In some example embodiments, using this location information, a position-aware prompt may be generated. For example, a text description may be generated to describe the at least one location of at least object within the third sample image. For example, a position-aware prompt may be generated by following the template: “The [O] is in block [P]” and it is noted that any other templates may be possible. Subsequently, the prompts 470 and 472 for all objects in the sample image 460 are concatenated with the original text prompt 480 for generating the sample image 460. This forms the input for the text encoder 494, enhancing the position-grounding ability of the vision-language model.

The model in focus, BILP, may be adapted to the needs for Vision-Language Pretraining (VLP) in some examples, which can be used for image-to-text retrieval (TR) and/or text-to-image retrieval (IR). In some example embodiments, end-to-end training using conventional objectives may be conducted. In some example embodiments, the training process involves the use of Language Modeling (LM) loss, Image-Text Matching (ITM) loss, and Image-Text Contrastive (ITC) loss. Note that the positional information of the object is only required during the pre-training stage. For downstream tasks, the model may be further fined using standard end-to-end methods, without the need for object information.

With the utilization of the annotation-free attention maps aligned with corresponding text inputs on generated images, model performance of the unsupervised learning can be enhanced. Extensive experiments that show consistent improvements in baseline models across various downstream tasks, including image classification, detection, segmentation, and image-text retrieval. By utilizing the proposed solution, it is possible to close the performance gap between unsupervised pretraining on synthetic data and real-world scenarios.

Below Tables 1-4 shows some results for different unsupervised learning techniques according to the example embodiments of the present disclosure in comparison with some conventional training schema. As outlined in Table 1, various terms denote different pretraining methods. “Random initiation” implies no pretraining, “supervised” refers to pretraining with ImageNet&labels, and “real images” indicates self-supervised pretraining on ImageNet. “Synthetic images” stands for self-supervised pretraining on purely synthetic images, while “synthetic images with the unsupervised learning in the present disclosure” signifies the adapted method using synthetic images with free attention masks in the present disclosure. “Mix” involves a blend of masked synthetic and real images.

For object detection and segmentation task, the pretrained network is utilized as a feature extractor. For object detection and instance segmentation in COCO, the Mask-RCNN is modified to be equipped with feature pyramid networks. The complete model is fine-tuned on the training dataset, following a standard 1× schedule (12 epochs), and the results are evaluated as bounding box AP (AP^{b}) and instance mask AP(AP^{m}). In the case of semantic segmentation for Cityspace, the model is fine-tuned, reporting the results in terms of mIoU (mean Intersection over Union).

As shown in Table 1, self-supervised pretraining using purely synthetic data leads to a noticeable performance discrepancy on the COCO and City Space datasets when compared to the use of purely real data. However, with the introduction of the free attention mask, it is observed a marked improvement in results: an increase of 1.3% and 1.1% on the COCO dataset, and 0.8% on the CitySpace dataset. This improvement narrows the gap with real data to an almost negligible level. These findings underscore the efficacy of the solution in the present disclosure to instance-level contrastive learning, facilitated by the use of free attention masks. Moreover, when combining both real and synthetic data, not only an enhancement in performance but also a surpassing of the results are achieved using purely real data. This is accomplished without incurring any costs associated with human annotation or data collection.

TABLE 1
Example downstream results for contrastive learning

| | COCO | | Cityspace |
|---|---|---|---|
| Training scheme | AP^{b} | AP^{m} | mIoU |
| random initiation | 31.4 | 28.5 | 65.2 |
| supervised learning | 39.2 | 35.5 | 74.2 |
| real images | 37.7 | 34.2 | 74.8 |
| synthetic images | 36.4 | 33.1 | 73.7 |
| synthetic images with the | 37.7 | 34.2 | 74.5 |
| unsupervised learning in | (+1.3) | (+1.1) | (+0.8) |
| the present disclosure | | | |
| mixed (synthetic and real) | 38.7 | 34.8 | 75.0 |
| images | | | |

Table 2 reveals a pattern similar to that observed with SimCLR: when pretraining is conducted solely on synthetic images, there is a noticeable performance gap compared to pretraining on real images. Yet, interestingly, the results obtained using only synthetic images can rival and even surpass those achieved through supervised learning on real images, a process that typically requires substantial human annotation and collection efforts. Furthermore, the application of free attention masks enhances the performance on synthetic images to a level comparable with that on real data, effectively bridging the gap between synthetic and real images. When pretraining incorporates both synthetic and real images, the results show an improvement over both supervised learning with real data and self-supervised pretraining, all without the need for human labor.

TABLE 2
Example downstream results for contrastive learning

| | PASVOC | COCO | Cityspace |
|---|---|---|---|
| Training scheme | AP^{b}₅₀ | AP^{b} | mIoU |
| random initiation | 59.0 | 31.4 | 65.2 |
| supervised learning | 81.6 | 39.2 | 74.2 |
| real images | 82.4 | 39.8 | 75.0 |
| synthetic images | 81.6 | 37.9 | 74.1 |
| synthetic images with the | 82.1 | 38.3 | 74.8 |
| unsupervised learning in | (+0.5) | (+0.4) | (+0.7) |
| the present disclosure | | | |
| mixed (synthetic and real) | 82.6 | 40.1 | 75.3 |
| images | | | |

As shown in Table 3, Masked Auto Encoder (MAE) achieves consistent trend results when compared to MoCo-v2. Utilizing free attention masks can assist in bridging the discrepancy between synthetic and real data. Additionally, by exclusively employing synthetic data, which does not require human annotation or collection costs, the proposed solution in the present disclosure can significantly outperform fully annotated supervised training (83.8 vs. 81.0).

TABLE 3
Example downstream results for masked modeling (MAE)

| | ImageNet | ADE20K |
|---|---|---|
| Training scheme | AP^{b}₅₀ | mIoU |
| supervised learning | 81.0 | 47.4 |
| real images | 83.6 | 48.1 |
| synthetic images | 82.7 | 47.6 |
| synthetic images with unsupervised | 83.2 | 48.0 |
| learning in the present disclosure | (+0.5) | (+0.4) |
| mixed (synthetic and real) images | 83.8 | 48.5 |

Table 4 illustrates that with free attention masks, it provides position-aware prompts, enables the model to attain a substantial improvement over results obtained using purely synthetic data. Furthermore, combining synthetic data with the mask and real data considerably enhances the results, all without incurring any costs associated with human annotation or data collection.

TABLE 4
Example downstream results for vision-language pretraining

MS-COCO

| Training scheme | tr@1 | ir@1 |
|---|---|---|
| real images | 58.1 | 44.2 |
| VQGAN | 35.6 | 32.0 |
| DALL-E2 | 44.5 | 38.6 |
| Stable | 52.3 | 40.9 |
| synthetic images with unsupervised | 54.9 | 43.8 |
| learning in the present disclosure | (+2.6) | (+2.9) |
| mixed (synthetic and real) images | 60.8 | 46.2 |

The unsupervised learning according to the example embodiments of the present disclosure achieves significantly better results compared to simply applying original unsupervised pretraining protocols on model-generated data. By leveraging free attention maps, the performance gap between unsupervised pretraining on synthetic data and real-world scenarios can possibly be closed. Moreover, mixing synthetic data with real-world data for pretraining can further boost performance.

It would be appreciated that the above tables only provide some example results which are shown for the purpose of illustration only without suggesting any limitations to the embodiments of the present disclosure. Depending on the datasets, the model setup, and the model training strategies, the results may be varied.

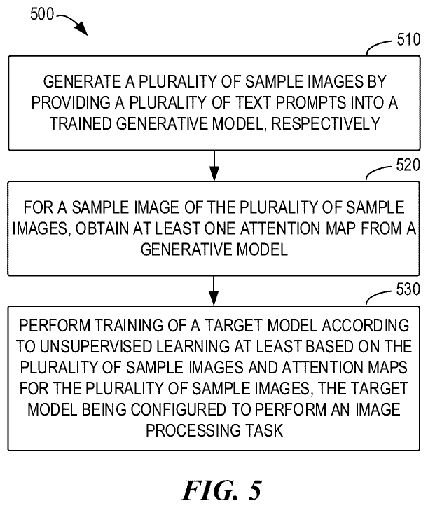

FIG. 5 illustrates a flowchart of a computer-implemented method 500 in accordance with some example embodiments of the present disclosure. The method 500 may be implemented at the model training system 200 as illustrated in FIG. 2.

At block 510, the model training system 200 generates a plurality of sample images using a trained generative model.

At block 520, for a sample image of the plurality of sample images, the model training system 200 obtains at least one attention map from a generative model, the at least one attention map being determined by the generative model for generating the sample image, an attention map indicating visual elements of an object within the sample image.

At block 530, the model training system 200 performing training of a target model according to unsupervised learning at least based on the plurality of sample images and attention maps for the plurality of sample images, the target model being configured to perform an image processing task.

In some example embodiments, generating the plurality of sample images comprises: generating a plurality of sample images by providing a plurality of text prompts into a trained generative model, respectively, and wherein an attention map for a sample image indicates visual elements of an object indicated by a text prompt.

In some example embodiments, the method 500 further comprises: generating the plurality of text prompts through at least one of the following: filling at least one of a plurality of object class names into a text template, to obtain at least one text prompt, or providing at least one of the plurality of object class names into a trained word-to-sentence model, to obtain at least one text prompt generated by the word-to-sentence model.

In some example embodiments, the unsupervised learning comprises contrastive learning, and wherein performing training of the target model comprises: for a first sample image of the plurality of sample images that includes at least two objects, for at least one feature of the first sample image by the target model, masking the at least one feature with at least two attention maps for the at least two objects, respectively, to obtain at least two masked features for the at least two objects, a masked feature comprising feature information related to an object; constructing at least one positive sample pair and at least one negative sample pair from the at least two masked features, a positive sample pair comprising a pair of masked features for a same object, and a negative sample pair comprising a pair of masked features for a pair of different objects; determining a contrastive loss for the first sample image based on at least one similarity between the at least one positive sample pair and at least one similarity between the at least one negative sample pair; and training the target model based on the contrastive loss.

In some example embodiments, masking the at least one feature with at least two attention maps for the at least two objects, respectively, to obtain at least two masked features for the at least two objects comprises: applying a first cropping operation and a second cropping operation on the first sample image, respectively, to generate a first cropped image and a second cropped image; applying the first cropping operation and the second cropping operation on at least two attention maps for the at least two objects, respectively, to obtain a first set of cropped attention maps for the first cropped image, and a second set of cropped attention maps for the second cropped image; for a first feature of the first cropped image extracted by the target model, masking the first feature with the first set of cropped attention maps, respectively, to obtain a first set of masked features for the at least two objects; and for a second feature of the second cropped image extracted by the target model, masking the second feature with the second set of cropped attention maps, respectively, to obtain a second set of masked features for the at least two objects.

In some example embodiments, the unsupervised learning comprises masked modeling, and wherein performing training of the target model comprises: for a second sample image of the plurality of sample images, masking at least one patch in the second sample image based on the at least one attention map for the second sample image; and training the target model by performing masked modeling to reconstruct the at least one masked patch in the second sample image.

In some example embodiments, an attention map for a sample image comprises importance scores of visual elements within the sample image with respect to an object; and wherein masking at least one patch in the second sample image comprises: masking the at least one patch in the second sample image based on importance scores comprised in the at least one attention map for the second sample image, the at least one masked patch corresponding to higher importance scores in an attention map than unmasked patches.

In some example embodiments, masking at least one patch in the second sample image comprises: in a first training iteration of the target model, masking a first ratio of patches among the plurality of patches in the second sample image, the first ratio being larger than a second ratio of patches masked in the second sample image in a training iteration earlier than the first training iteration.

In some example embodiments, the unsupervised learning comprises vision-and-language pretraining, and wherein performing training of the target model comprises: for a third sample image of the plurality of sample images, determining at least one location of at least object within the third sample image based on at least one attention map for the third sample image; and performing the vision-and-language pretraining of the target model based at least in part on the third sample image and location information indicating the at least one location of the at least object within the third sample image.

In some example embodiments, performing the vision-and-language pretraining of the target model comprises: generating a text description to describe the at least one location of at least object within the third sample image; and performing the vision-and-language pretraining of the target model based at least in part on the third sample image, the location information, and the text description.

In some example embodiments, the generative model comprises a diffusion model for text-to-image generation.

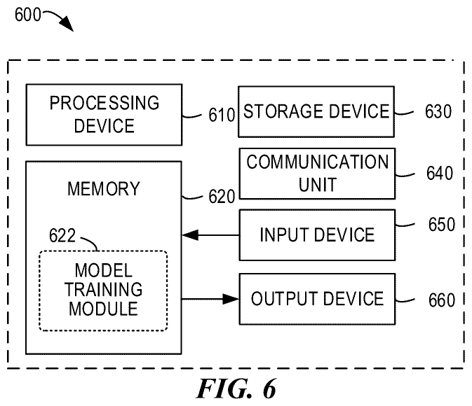

FIG. 6 illustrates a schematic block diagram of a computing system/device 600 in which various embodiments of the present disclosure can be implemented. It would be appreciated that the computing system/device 600 as shown in FIG. 6 is merely provided as an example, without suggesting any limitation to the functionalities and scope of embodiments of the present disclosure.

As shown in FIG. 6, the computing system/device 600 is in form of a general-purpose computing device. Components of the computing system/device 600 may include, but are not limited to, one or more processors or processing devices 610, a memory 620, a storage device 630, one or more communication units 640, one or more input devices 650, and one or more output devices 660.

In some example embodiments, the computing system/device 600 may be implemented as a device with computing capability, such as a computing device, a computing system, a server, a mainframe and the like.

The processing device 610 can be a physical or virtual processor and can execute various processing based on the programs stored in the memory 620. In a multi-processor system, a plurality of processing units execute computer-executable instructions in parallel so as to enhance parallel processing capability of the computing system/device 600. The processing device 610 may include a central processing unit (CPU), a graphics processing unit (GPU), a microprocessor, a controller, and/or a microcontroller.

The computing system/device 600 usually includes various computer storage media. Such media may be any available media accessible by the computing system/device 600, including but not limited to, volatile and non-volatile media, or detachable and non-detachable media. The memory 620 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 630 may be any detachable or non-detachable medium and may include computer-readable medium such as a memory, a flash memory drive, a magnetic disk or any other media that can be used for storing information and/or data and are accessible by the computing system/device 600.

The computing system/device 600 may further include additional detachable/non-detachable, volatile/non-volatile memory media. Although not shown in FIG. 6, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 640 implements communication with another computing device via the communication medium. In addition, the functionalities of components in the computing system/device 600 may be implemented by a single computing cluster or a plurality of computing machines that can communicate with each other via communication connections. Thus, the computing system/device 600 may operate in a networked environment using a logic connection with one or more other servers, network personal computers (PCs), or further general network nodes.

The input device 650 may include one or more of a variety of input devices, such as a mouse, keyboard, data import device and the like. The output device 660 may be one or more output devices, such as a display, data export device and the like. By means of the communication unit 640, the computing system/device 600 may further communicate with one or more external devices (not shown) such as storage devices and display devices, one or more devices that enable the user to interact with the computing system/device 600, or any devices (such as a network card, a modem and the like) that enable the computing system/device 600 to communicate with one or more other computing devices, if required. Such communication may be performed via input/output (I/O) interfaces (not shown).

In some example embodiments, as an alternative of being integrated on a single device, some or all components of the computing system/device 600 may also be arranged in the form of cloud computing architecture. In the cloud computing architecture, the components may be provided remotely and work together to implement the functionalities described in the present disclosure. In some example embodiments, cloud computing provides computing, software, data access and storage service, which will not require end users to be aware of the physical locations or configurations of the systems or hardware provisioning these services. In various embodiments, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The computing system/device 600 may be used to implement resource management in accordance with various embodiments of the present disclosure. The memory 620 may include one or more modules having one or more program instructions. These modules may be accessed and run by the processing unit 610 to perform functions of various embodiments described herein. For example, the memory 620 may include a model training module 622 for performing model training in accordance with the example embodiments of the present disclosure. As shown in FIG. 6, the computing system/device 600 may obtain an input required for model training through the input device 650 and provide the corresponding output through the output device 660. In some example embodiments, the computing system/device 600 may further receive an input from other devices (not shown) via the communication unit 640.

In some example embodiments of the present disclosure, there is provided a computer program product comprising instructions which, when executed by a processor of an apparatus, cause the apparatus to perform steps of any one of the methods described above.

In some example embodiments of the present disclosure, there is provided a computer readable medium comprising program instructions for causing an apparatus to perform at least steps of any one of the methods described above. The computer readable medium may be a non-transitory computer readable medium in accordance with some example embodiments.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments of the present disclosure are illustrated and described as block diagrams, flowcharts, or using some other pictorial representations, it will be appreciated that the blocks, apparatuses, systems, techniques, or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods/processes as described above. Generally, program modules include routines, programs, libraries, objects, classes, components, data structures, or the like that perform particular tasks or implement particular abstract types. The functionality of the program modules may be combined or split between program modules as desired in various embodiments. Computer-executable instructions for program modules may be executed within a local or distributed device. In a distributed device, program modules may be located in both local and remote storage media.

The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods disclosed herein may be written in any combination of one or more programming languages. The program code may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method comprising:
generating a plurality of sample images using a trained generative model;
for a sample image of the plurality of sample images, obtaining at least one attention map from a generative model, the at least one attention map being determined by the generative model for generating the sample image, an attention map indicating visual elements of an object within the sample image; and
performing training of a target model according to unsupervised learning at least based on the plurality of sample images and attention maps for the plurality of sample images, the target model being configured to perform an image processing task.

2. The method of claim 1, wherein generating the plurality of sample images comprises:
generating a plurality of sample images by providing a plurality of text prompts into a trained generative model, respectively, and
wherein an attention map for a sample image indicates visual elements of an object indicated by a text prompt.

3. The method of claim 2, further comprising:
generating the plurality of text prompts through at least one of the following:
filling at least one of a plurality of object class names into a text template, to obtain at least one text prompt, or
providing at least one of the plurality of object class names into a trained word-to-sentence model, to obtain at least one text prompt generated by the word-to-sentence model.

4. The method of claim 1, wherein the unsupervised learning comprises contrastive learning, and wherein performing training of the target model comprises: for a first sample image of the plurality of sample images that includes at least two objects,
for at least one feature of the first sample image by the target model, masking the at least one feature with at least two attention maps for the at least two objects, respectively, to obtain at least two masked features for the at least two objects, a masked feature comprising feature information related to an object;
constructing at least one positive sample pair and at least one negative sample pair from the at least two masked features, a positive sample pair comprising a pair of masked features for a same object, and a negative sample pair comprising a pair of masked features for a pair of different objects;
determining a contrastive loss for the first sample image based on at least one similarity between the at least one positive sample pair and at least one similarity between the at least one negative sample pair; and
training the target model based on the contrastive loss.

5. The method of claim 4, wherein masking the at least one feature with at least two attention maps for the at least two objects, respectively, to obtain at least two masked features for the at least two objects comprises:
applying a first cropping operation and a second cropping operation on the first sample image, respectively, to generate a first cropped image and a second cropped image;
applying the first cropping operation and the second cropping operation on at least two attention maps for the at least two objects, respectively, to obtain a first set of cropped attention maps for the first cropped image, and a second set of cropped attention maps for the second cropped image;
for a first feature of the first cropped image extracted by the target model, masking the first feature with the first set of cropped attention maps, respectively, to obtain a first set of masked features for the at least two objects; and
for a second feature of the second cropped image extracted by the target model, masking the second feature with the second set of cropped attention maps, respectively, to obtain a second set of masked features for the at least two objects.

6. The method of claim 1, wherein the unsupervised learning comprises masked modeling, and wherein performing training of the target model comprises: for a second sample image of the plurality of sample images,
masking at least one patch in the second sample image based on the at least one attention map for the second sample image; and
training the target model by performing masked modeling to reconstruct the at least one masked patch in the second sample image.

7. The method of claim 6, wherein an attention map for a sample image comprises importance scores of visual elements within the sample image with respect to an object; and wherein masking at least one patch in the second sample image comprises:
masking the at least one patch in the second sample image based on importance scores comprised in the at least one attention map for the second sample image, the at least one masked patch corresponding to higher importance scores in an attention map than unmasked patches.

8. The method of claim 6, wherein masking at least one patch in the second sample image comprises:
in a first training iteration of the target model, masking a first ratio of patches among the plurality of patches in the second sample image, the first ratio being larger than a second ratio of patches masked in the second sample image in a training iteration earlier than the first training iteration.

9. The method of claim 1, wherein the unsupervised learning comprises vision-and-language pretraining, and wherein performing training of the target model comprises: for a third sample image of the plurality of sample images,
determining at least one location of at least object within the third sample image based on at least one attention map for the third sample image; and
performing the vision-and-language pretraining of the target model based at least in part on the third sample image and location information indicating the at least one location of the at least object within the third sample image.

10. The method of claim 9, wherein performing the vision-and-language pretraining of the target model comprises:
generating a text description to describe the at least one location of at least object within the third sample image; and
performing the vision-and-language pretraining of the target model based at least in part on the third sample image, the location information, and the text description.

11. The method of claim 1, wherein the generative model comprises a diffusion model for text-to-image generation.

12. A system, comprising:
at least one processor; and
at least one memory communicatively coupled to the at least one processor and comprising computer-readable instructions that upon execution by the at least one processor cause the at least one processor to perform acts comprising:
generating a plurality of sample images by providing a plurality of text prompts into a trained generative model, respectively;
for a sample image of the plurality of sample images, obtaining at least one attention map from a generative model, the at least one attention map being determined by the generative model for generating the sample image, an attention map indicating visual elements of an object within the sample image; and
performing training of a target model according to unsupervised learning at least based on the plurality of sample images and attention maps for the plurality of sample images, the target model being configured to perform an image processing task.

13. The system of claim 12, wherein generating the plurality of sample images comprises:
generating a plurality of sample images by providing a plurality of text prompts into a trained generative model, respectively, and
wherein an attention map for a sample image indicates visual elements of an object indicated by a text prompt.

14. The system of claim 12, wherein the unsupervised learning comprises contrastive learning, and wherein performing training of the target model comprises: for a first sample image of the plurality of sample images that includes at least two objects,
for at least one feature of the first sample image by the target model, masking the at least one feature with at least two attention maps for the at least two objects, respectively, to obtain at least two masked features for the at least two objects, a masked feature comprising feature information related to an object;
constructing at least one positive sample pair and at least one negative sample pair from the at least two masked features, a positive sample pair comprising a pair of masked features for a same object, and a negative sample pair comprising a pair of masked features for a pair of different objects;
determining a contrastive loss for the first sample image based on at least one similarity between the at least one positive sample pair and at least one similarity between the at least one negative sample pair; and
training the target model based on the contrastive loss.

15. The system of claim 14, wherein masking the at least one feature with at least two attention maps for the at least two objects, respectively, to obtain at least two masked features for the at least two objects comprises:
applying a first cropping operation and a second cropping operation on the first sample image, respectively, to generate a first cropped image and a second cropped image;
applying the first cropping operation and the second cropping operation on at least two attention maps for the at least two objects, respectively, to obtain a first set of cropped attention maps for the first cropped image, and a second set of cropped attention maps for the second cropped image;
for a first feature of the first cropped image extracted by the target model, masking the first feature with the first set of cropped attention maps, respectively, to obtain a first set of masked features for the at least two objects; and
for a second feature of the second cropped image extracted by the target model, masking the second feature with the second set of cropped attention maps, respectively, to obtain a second set of masked features for the at least two objects.

16. The system of claim 12, wherein the unsupervised learning comprises masked modeling, and wherein performing training of the target model comprises: for a second sample image of the plurality of sample images,
masking at least one patch in the second sample image based on the at least one attention map for the second sample image; and
training the target model by performing masked modeling to reconstruct the at least one masked patch in the second sample image.

17. The system of claim 16, wherein an attention map for a sample image comprises importance scores of visual elements within the sample image with respect to an object; and wherein masking at least one patch in the second sample image comprises:
masking the at least one patch in the second sample image based on importance scores comprised in the at least one attention map for the second sample image, the at least one masked patch corresponding to higher importance scores in an attention map than unmasked patches.

18. The system of claim 16, wherein masking at least one patch in the second sample image comprises:
in a first training iteration of the target model, masking a first ratio of patches among the plurality of patches in the second sample image, the first ratio being larger than a second ratio of patches masked in the second sample image in a training iteration earlier than the first training iteration.

19. The system of claim 12, wherein the unsupervised learning comprises vision-and-language pretraining, and wherein performing training of the target model comprises: for a third sample image of the plurality of sample images,
determining at least one location of at least object within the third sample image based on at least one attention map for the third sample image; and
performing the vision-and-language pretraining of the target model based at least in part on the third sample image and location information indicating the at least one location of the at least object within the third sample image.

20. A non-transitory computer-readable storage medium, storing computer-readable instructions that upon execution by a device cause the device to perform acts comprising:
generating a plurality of sample images by providing a plurality of text prompts into a trained generative model, respectively;
for a sample image of the plurality of sample images, obtaining at least one attention map from a generative model, the at least one attention map being determined by the generative model for generating the sample image, an attention map indicating visual elements of an object within the sample image; and
performing training of a target model according to unsupervised learning at least based on the plurality of sample images and attention maps for the plurality of sample images, the target model being configured to perform an image processing task.
